(19) United States
(12) Patent Application Publication
(10) Pub. No.: US 2007/0266292 A1
(43) Pub. Date: Nov. 15, 2007

(54) Method and apparatus for reduced data block transmission in an automatic repeat request system

(76) Inventors: Marcel Korndewal, Amersfoort (NL); Wim Schaap, Kortenhoef (NL); Leon J. Zegers, Amsterdam (NL)

Correspondence Address: MOTOROLA INC, 600 NORTH US HIGHWAY 45, ROOM AS437, LIBERTYVILLE, IL, 60048-5343, US

(21) Appl. No.: 11/412,845

(22) Filed: Apr. 27, 2006

(51) Int. Cl. H04L 1/18

(52) U.S. Cl. 714/749

(57) ABSTRACT

A wireless transceiver apparatus (201, 203) and a method of operation in an Automatic Repeat Request (ARQ) mode is disclosed. On the transmitter side a packet of data (113) is fragmented into a series of sequential data blocks and each data block is assigned a block sequence number (601). At least a first data block of the series of sequential data blocks is sent to the receiver (603), and also a first block sequence number corresponding to the first data block. An acknowledgment timer is set (605) specifying a time interval in which to receive an acknowledgment message from the remote transceiver. If the acknowledgment timer has timed out, the transmitter side sends a discard message (607) to the receiver specifying at least a second block sequence number corresponding to at least a second data block, and specifying that said second data block is to be discarded.

### FIELD OF THE DISCLOSURE

The present invention relates generally to packet based wireless communications systems employing automatic repeat request (ARQ) mechanisms and more particularly to a method and apparatus for reducing data block transmissions in such wireless packet based communications systems.

### BACKGROUND

Automatic repeat request (ARQ) mechanisms make use of retransmission in packet based wireless communications systems, as well as other communications systems, to increase the probability that data has been transferred from a transmitter to a receiver. Retransmission of data however may reduce a system's net data throughput which may be of particular significance for various wireless communications systems.

In wireless communications systems based on the IEEE 802.16 standard, various timers are defined with respect to the ARQ mechanism. Specifically, a block lifetime timer is assigned to each ARQ block such that the blocks are discarded at the expiry of the timer. However, in general any ARQ block will only be a fraction of a Medium Access Control Layer (MAC) Service Data Unit (MSDU). Therefore if a fraction of an MSDU is discarded due to timer expiry, the entire MSDU becomes obsolete, and it is futile and also wasteful of bandwidth, to transmit and/or retransmit any remaining ARQ blocks associated with the same MSDU.

### BRIEF DESCRIPTION OF THE DRAWINGS

FIG. 1 is a block diagram of a data packet structure.

FIG. 2 is a block diagram of a wireless network employing automatic repeat request (ARQ).

FIG. 3 is a block diagram of a wireless mobile station in accordance with the various embodiments.

FIG. 4 is a diagram illustrating a high-level architecture of a mobile station and a base station in accordance with the various embodiments.

FIG. 5 is a flow chart illustrating high level operation of a receiver in accordance with various embodiments.

FIG. 6 is a flow chart illustrating high level operation of a transmitter in accordance with various embodiments.

FIG. 7 is a flow chart illustrating relevant segments of a transmitter state wherein the transmitter is operating in accordance with an embodiment.

FIG. 8 is a flow chart illustrating relevant segments of a receiver state wherein the receiver is operating in accordance with an embodiment.

FIG. 9 is a message flow diagram illustrating an exemplary message flow of a transmitter and receiver in accordance with an embodiment.

FIG. 10 is a block diagram illustrating operation of a sliding receiver window.

FIG. 11 is a block diagram illustrating operation of a sliding receiver window dance with an embodiment.

### DETAILED DESCRIPTION

Methods and apparatuses for reducing data block transmission in systems employing Automatic Repeat Request (ARQ) are provided herein.

In a first aspect of the various embodiments, a method of operating a wireless transceiver in an Automatic Repeat Request (ARQ) mode comprises fragmenting a packet of data into a series of sequential data blocks and assigning each of the data blocks a block sequence number; sending at least a first data block from the series of sequential data blocks, and a first block sequence number corresponding to the first data block, to a remote wireless transceiver; setting an acknowledgment timer specifying a time interval in which to receive an acknowledgment message from the remote transceiver, the acknowledgment message corresponding to the first data block; determining that the acknowledgment timer has timed out; and sending a discard message to the remote transceiver specifying at least a second block sequence number corresponding to at least a second data block, and specifying that the second data block is to be discarded.

A second aspect of the various embodiments is a method of operating a wireless transceiver in an ARQ mode comprising receiving from a remote transceiver at least a first data block including a first block sequence number, the first data block being from a series of sequential data blocks forming a packet; receiving from the remote transceiver a discard message specifying at least a second block sequence number corresponding to at least a second data block, where the discard message specifies that the second data block is to be discarded; and discarding the second data block.

A third aspect is a wireless communication station comprising a transceiver; a processor coupled to the transceiver which has a medium access control layer, and configured to fragment a packet of data into a series of sequential data blocks and assign each of the data blocks a block sequence number; send at least a first data block from the series of sequential data blocks, and a first block sequence number corresponding to the first data block, to a remote wireless transceiver; set an acknowledgment timer specifying a time interval in which to receive an acknowledgment message of the first data block from the remote transceiver; determine that the acknowledgment timer has timed out; and send a discard message to the remote transceiver specifying at least a second block sequence number corresponding to at least a second data block, and specifying that the second data block is to be discarded.

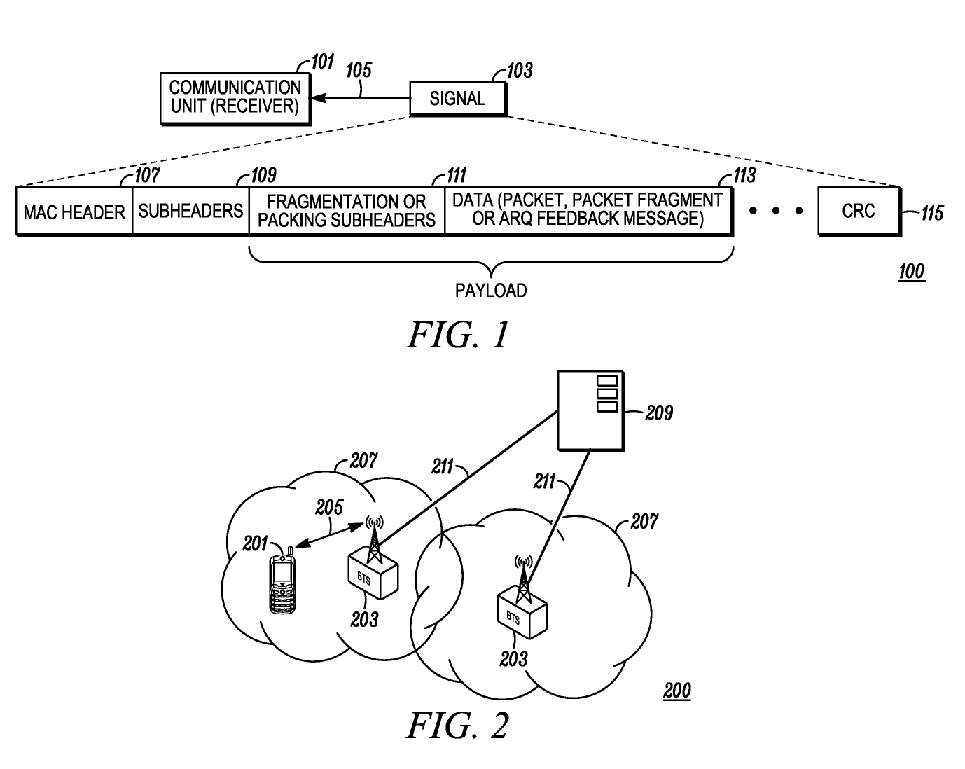

Turning now to the drawings wherein like numerals represent like components, FIG. 1 illustrates the structure of a signal burst 103 from a transmitter to a receiver 101 over an air interface 105. The signal burst 103 will generally comprise at least one packet of data having the structure of a Medium Access Control (MAC) header 107, various sub-headers 109, further fragmentation or packing sub-headers 111, a data portion 113, and in some embodiments, a cyclic redundancy check portion 115.

The data 113 may contain a data packet structured by a Medium Access Control Layer (MAC) wherein the data packet may be referred to in some embodiments as a Service Data Unit (SDU), or more specifically a MAC SDU (MSDU). Additionally, such MSDUs may be partitioned or “fragmented” to produce packet fragments, or smaller data blocks. Groups of such MSDU fragments or MSDU data blocks are subsequently transmitted in “Protocol Data Units” (PDUs). Therefore, the payload may be a complete MSDU, or in the case of large MSDUs, may be one of more fragments of an MSDU, which are contained in a PDU. Such fragmentation operation is dictated by Quality of Service (QoS) requirements and by the efficient use of bandwidth as understood by those of ordinary skill.

The data 113 may also be “packed” data, that is, the MAC layer of the transmitter may discretionally pack several MSDUs into one PDU. Additionally, the transmitter MAC layer may pack various MSDU fragments into a single PDU. For ARQ systems, the packing and/or fragmentation sub-headers 111 will contain a Block Sequence Number (BSN) which the ARQ system uses to identify missing or otherwise lost fragments so that the fragments may be retransmitted.

Generally, when packing is employed, the packing sub-header 111 will also contain fragmentation information for the MSDU or fragment thereof contained within data 113. However, if packing is not used, then sub-headers 111 will be a fragmentation sub-header and contain the fragmentation information for the corresponding fragment. Therefore, the configuration of the signal 103 payload may be a sequence of sub-headers 111 and corresponding data 113 portions wherein the fragmentation subheader or each packing sub-header contains a BSN and/or fragmentation information for the specific fragment.

Further, the signal 103 payload may contain one or more initial PDU transmissions combined with one or more PDU retransmissions. The BSN of a fragment may be an 11-bit field in some embodiments in which 802.16 is employed. Fragmentation information may be a 2-bit field and indicate whether a fragment is a “First Fragment,” “Continuing Fragment,” “Last Fragment,” or “Unfragmented” by the binary values “10,” “11,” “01,” and “00” respectively.

Lastly, data 113 may also contain an ARQ feedback message, which may be in combination with other PDU data as discussed above. For example, an ARQ feedback message may be “piggybacked” with other data by using a packing subheader. However, an ARQ feedback message may also be sent as a stand alone MAC management message without a subheader. The data 113 may also employ encryption in some embodiments.

Signal 103 may include a Cyclic Redundancy Check (CRC) field 115 in some embodiments which may cover the MAC header 107 as well as data 113. Further, in some embodiments the MAC header 107 will contain a CRC-8 header checksum and CRC field 115 may contain a CRC-32 checksum to cover the data. If encryption is used as mentioned above, the CRC field will be determined subsequent to encryption operations. Signal 103 may also include padding (not shown).

In ARQ systems, an MSDU may be logically segmented into a series of data blocks and subsequently encapsulated into PDUs as discussed briefly above. The BSN, which is contained in the fragmentation or packing sub-headers 111 likewise as discussed above, will correspond to the first data block of the series of data blocks after the sub-header 111, which are being transmitted together. For retransmission, the transmitter may make a policy decision as to whether retransmitted data blocks are arranged in the same PDUs.

FIG. 2 illustrates a communications network 200, with various base stations 203, each base station 203 having a corresponding radio coverage area 207. In general, base station radio coverage areas-may overlap and, in general, form an overall network coverage area. A coverage area may comprise a number of base station coverage areas 207, which may form a contiguous radio coverage area. However, it is not required to have contiguous coverage and therefore the coverage area may alternatively be distributed throughout an overall network coverage area. Furthermore, each base station 203 may communicate with a number of mobile stations such as mobile station 201, via an air interface 205. The mobile station 201 may communicate with various base stations via handover operations as the mobile station 201 moves throughout the network 200 radio coverage areas.

A number of base stations 203 may be connected to a base station controller 209 via backhaul connections 211. The overall network may comprise any number of base station controllers, each controlling a number of base stations. Note that the base station controller 209 may alternatively be implemented as a distributed function among the base stations. The base stations 203 may communicate with the mobile station 201 via any number of standard air interfaces such as, but not limited to, UMTS, E-UMTS, CDMA2000, 802.11 or 802.16.

The base stations 203 may perform a number of control functions such as, but not limited to, a Radio Link Control (RLC) function and Medium Access Control (MAC) function. Base station controller 209 may provide a centralized Radio Resource Management (RRM) function to synchronize various functions between the base stations 203 such as, but not limited to, scheduling and segmentation and reassembly functions as well as to coordinate the RLC and MAC functions between the various base stations 203.

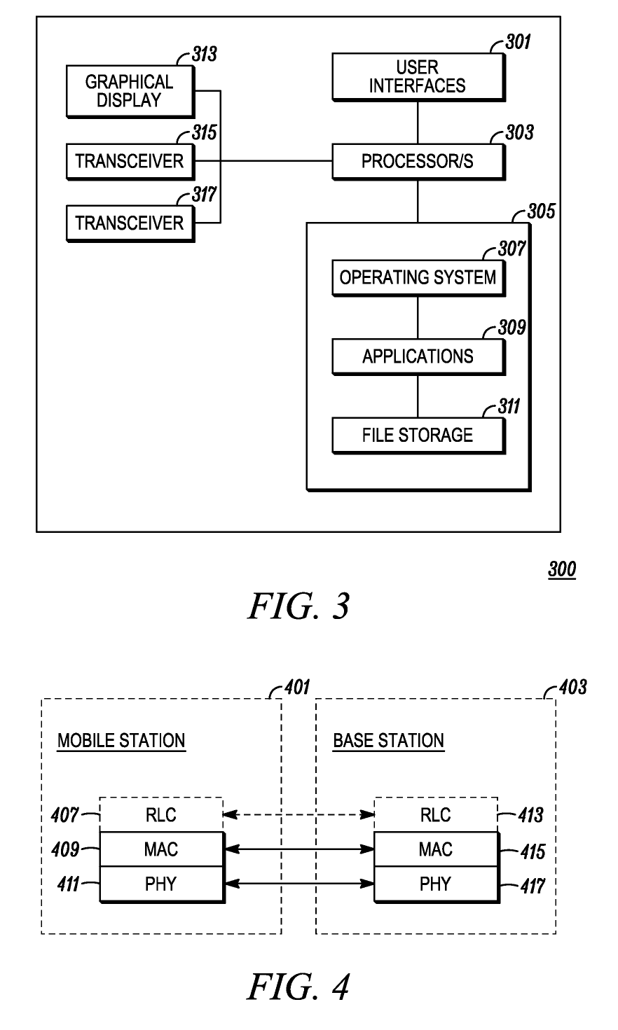

FIG. 3 is a block diagram illustrating the primary components of a mobile station in accordance with some embodiments. Mobile station 300 comprises user interfaces 301, at least one processor 303, and at least one memory 305. Memory 305 has storage sufficient for the mobile station operating system 307, applications 309 and general file storage 311. Mobile station 300 user interfaces 301, may be a combination of user interfaces including but not limited to a keypad, touch screen, voice activated command input, and gyroscopic cursor controls. Mobile station 300 has a graphical display 313, which may also have a dedicated processor and/or memory, drivers etc. which are not shown in FIG. 3.

It is to be understood that FIG. 3 is for illustrative purposes only and is for illustrating the main components of a mobile station in accordance with the present disclosure, and is not intended to be a complete schematic diagram of the various components and connections there-between required for a mobile station. Therefore, a mobile station may comprise various other components not shown in FIG. 3 and still be within the scope of the present disclosure.

Returning to FIG. 3, the mobile station 300 may also comprise a number of transceivers such as transceivers 315 and 317. Transceivers 315 and 317 may be for communicating with various wireless networks using various standards such as, but not limited to, UMTS, E-UMTS, CDMA2000, 802.11, 802.16, etc.

Memory 305 is for illustrative purposes only and may be configured in a variety of ways and still remain within the scope of the various embodiments herein disclosed. For example, memory 305 may be comprised of several elements each coupled to the processor 303. Further, separate processors-and memory elements may be dedicated to specific tasks such as rendering graphical images upon a graphical display. In any case, the memory 305 will have at least the functions of providing storage for an operating system 307, applications 309 and general file storage 311 for mobile station 300. In some embodiments, applications 309 may comprise a software stack having a Medium Access Control (MAC) layer that communicates with a stack MAC layer in a base station or base station controller.

Turning now to FIG. 4, mobile station and base station architectures in accordance with the various embodiments are illustrated. Mobile stations 401 comprises a stack having a Radio Link Controller (RLC) 407, a Medium Access Controller (MAC) 409, and a Physical Layer (PHY) 411. Base station 403 similarly has an RLC 413, MAC 415 and PHY 417.

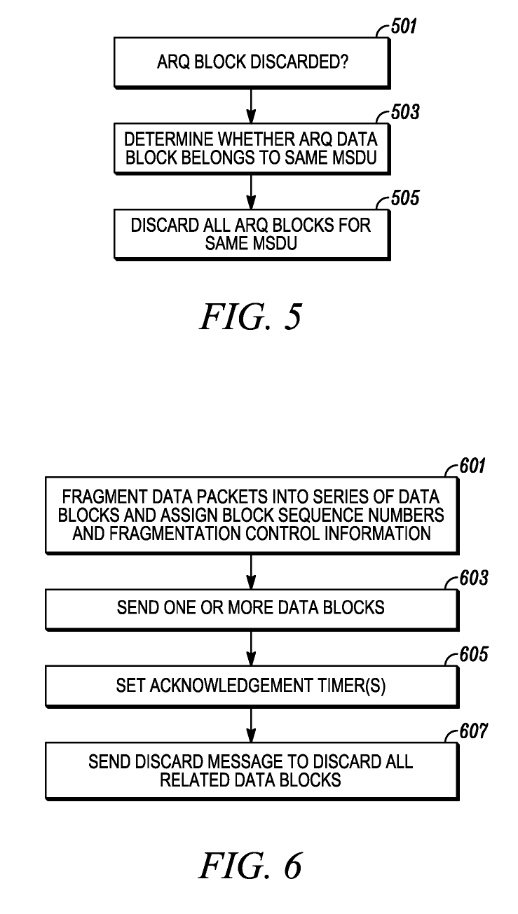

FIG. 5 illustrates high level operation of a receiver, operating in an ARQ mode, in accordance with various embodiments. Initial operation begins with notification or a determination that an ARQ data block or blocks has/have been discarded 501. Next, as shown in block 503, the receiver determines whether the discarded ARQ block or blocks belongs to an MSDU for which other ARQ blocks have already been received. If so, then all ARQ data blocks corresponding to the failed MSDU are discarded as shown in block 505.

A high level transmitter operation in accordance with various embodiments is illustrated by FIG. 6. In step 601, the transmitter may fragment data packets into a series of data blocks and assign Block Sequence Numbers (BSNs) and/or fragmentation control information. One or more of the data blocks is then sent to a receiver as shown in step 603.

The transmitter will set one or more acknowledgement timers, as shown in step 605, and wait for an ACK or NACK message from the receiver. This step may include a number of retransmit attempts based on one or more of the step 605 timers timing out. However, after final timeout, the MSDU can be considered to have failed. Therefore, in step 607, the transmitter will send a discard message to the receiver indicating that other ARQ data blocks that are part of the same MSDU should be discarded.

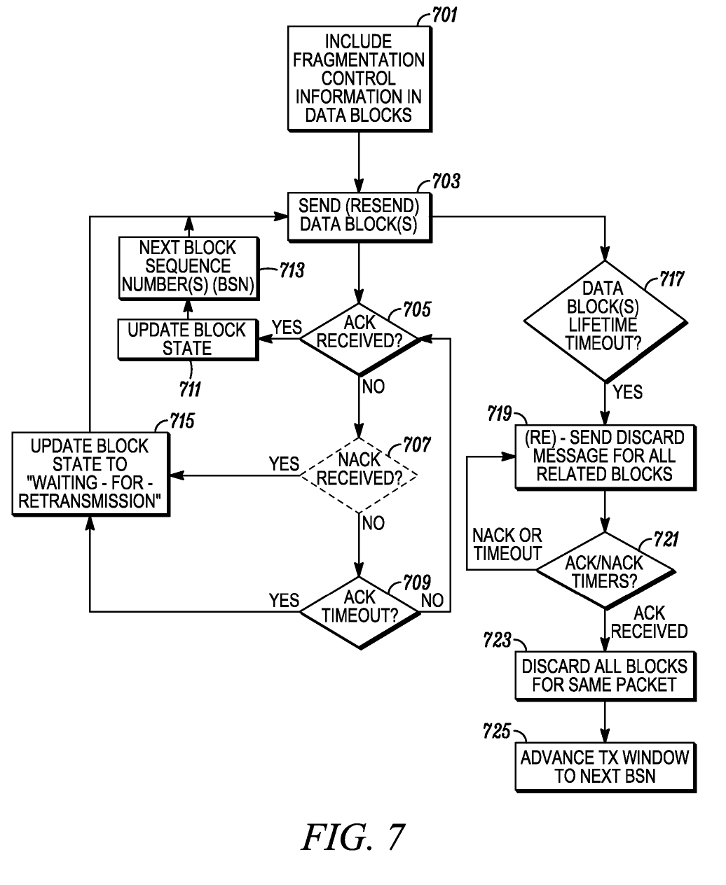

Segments of the transmitter state machine useful for understanding the various embodiments in a transmitting equipment are illustrated by FIG. 7. However, it is to be understood that FIG. 7 is not intended to be a full and complete description of the transmitter state machine, but rather is intended to provide those details necessary for understanding the various embodiments. Therefore, a transmitter state machine may comprise various other steps or procedures not shown by FIG. 7, and such transmitters employing the procedures illustrated by FIG. 7 with other such steps or procedures not shown, remain in accordance with the various embodiments herein disclosed.

Therefore, in step 701 the transmitter may segment an MSDU into a number of data blocks and include fragmentation control information in appropriate sub-headers, such as fragmentation or packing sub-headers 111 shown in FIG. 1 and discussed previously. One or more data blocks may then be sent by the transmitter as shown in step 703. It is to be understood that step 703 may also represent a retransmission of the ARQ mode such that a signal payload may comprise a number of initial data block transmissions and also retransmissions as was discussed previously with respect to FIG. 1.

In general as shown in step 705, the transmitter waits for the data block or blocks to be acknowledged by the receiver by an ACK message. If the data block is acknowledged then the block state will be updated. For example, a data block may be in one of four states; “not-sent,” “outstanding,” “discarded,” and “waiting-for-retransmission.” Therefore, a data block initial state is “not-sent.”

After the block is sent it becomes “outstanding” until an ACK is received in 705, or a “not-acknowledged” (NACK) is received as in 707, or if ACK timeout occurs as in 709. Upon receipt of an ACK message in 705, the block state will be updated to “discarded” by the transmitter. In this case, the block state may be updated to “discarded” in 711, after which a pointer may be moved to the next Block Sequence Number (BSN) or numbers as in 713, and the next data block or set of blocks may be sent in 703.

However, if a NACK is received as in 707, or if ACK timeout occurs as in 709, then the block state will be changed to “waiting for retransmission” in 715 and the block will be resent in 703.

Upon the initial sending of the data block in 703, a data block lifetime timer is also set, and the timeout is pending as shown in step 717. If the data block lifetime timer times out in 717, a discard message is sent to the receiver in 719. The discard message may in some embodiments provide an indication to the receiver of every related data block, that is, an indication of every data block BSN pertaining to the same MSDU for which the discarded block occurred. It is to be understood that various implementations are possible for indicating the related data blocks and that such implementations remain in accordance with the various embodiments disclosed herein. Thus, in one exemplary implementation of the various embodiments, the discard message may specify a range of BSNs which are to be discarded, by providing an initial BSN and a final BSN. Further, in some embodiments the receiving side may infer whether certain data blocks belong to a discarded MSDU and therefore in such embodiments only a single BSN may be provided, for example an initial BSN or a final BSN. In other alternative embodiments, the discard message may provide an initial BSN for a new MSDU so that the receiving side may advance its receive window accordingly, in addition to deleting data blocks with BSNs corresponding to the failed MSDU.

Returning now to FIG. 7, the transmitter then waits for an ACK or NACK message in 721. The timer sequence for 721 may be identical to the sequence of 705, 707 and 709 in some embodiments, such that 721 will have the same time duration as 705, 707 and 709. Returning to 721, if a NACK is received, or if a timeout occurs, then the discard message will be resent in 719. Otherwise, after an ACK is received in 721, the transmitter will discard the data blocks in 723 and will advance a transmission (Tx) window to the next BSN to be sent.

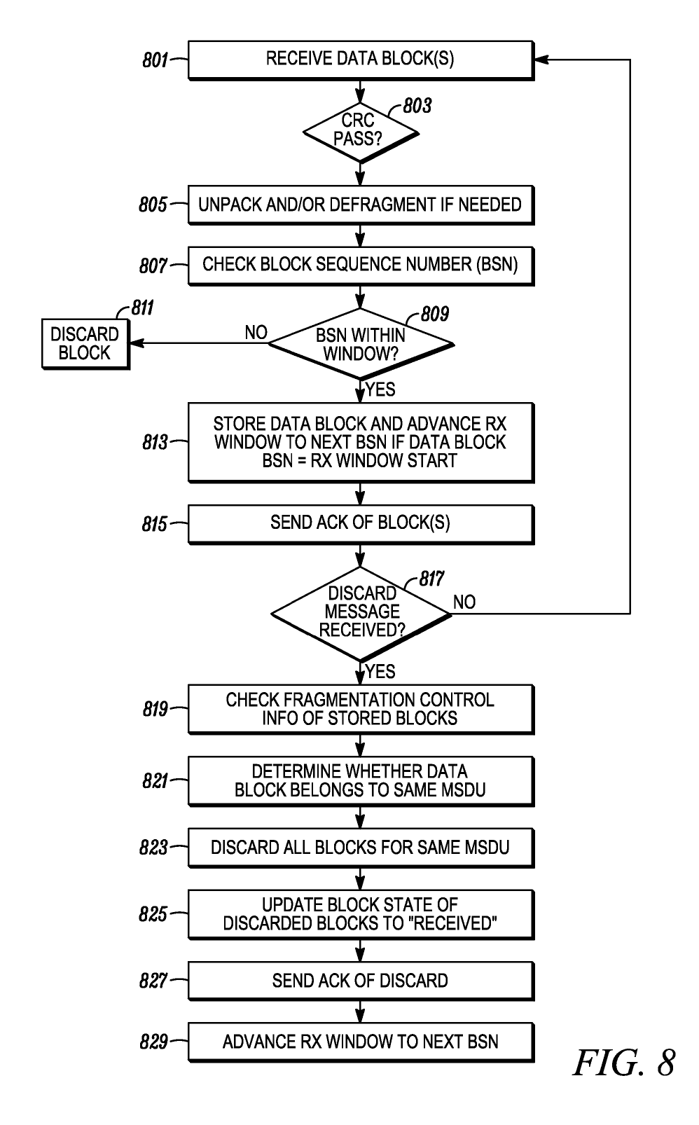

FIG. 8 illustrates the operation of a receiver state machine in accordance with the embodiments, and generally corresponding to the transmitter state machine illustrated by FIG. 7. Similar to the intent and understanding of FIG. 7, it is to be understood that FIG. 8 is not intended to be a full and complete description of the receiver state machine, but rather is intended to provide those details necessary for understanding the various embodiments. Therefore, a receiver state machine may comprise various other steps or procedures not shown by FIG. 8, and such receivers employing the procedures illustrated by FIG. 8 with other such steps or procedures not shown, remain in accordance with the various embodiments herein disclosed. Also, with respect to both FIGS. 7 and 8, it is to be understood that the various embodiments will be a transceiver station, that is, a base station or a mobile station having both transmitting and receiving capability and therefore both base stations and mobile stations may employ the various inventive methods and techniques herein disclosed in both the transmission and reception aspects.

Turning now to FIG. 8, a receiver receives a data block or data blocks in 801. For embodiments employing a Cyclic Redundancy Check (CRC) as was discussed with respect to FIG. 1, the CRC will be performed as in 803 and if the data passes, it will be unpacked or defragmented as needed in 805. The BSNs will then be checked in 807 to determine whether the received data block or data blocks is/are within the expected window as in 809. If not, then the blocks will be discarded in 811.

If the data block was in fact within the appropriate BSN window then the data block may be stored in 813, and the receive (Rx) window may be advanced to the next expected BSN if the received data block BSN is equal to the current Rx window start pointer value. The receiver will then send an ACK message to the transmitter in 815. During the normal operation of the receiver in ARQ mode, various blocks will be received such that the process of 801 through 815 will repeat until the successful reception of one or more MSDUs or unless, a discard message is received as in 817. If a discard message is not received in 817, the receiver will continue to receive data blocks in 801 that are expected within the Rx window. However, if a discard message is received as in 817, the receiver will determine whether currently stored data blocks belong to the same MSDU as blocks specified by the discard message.

As discussed above with respect to the transmitter states illustrated by FIG. 7, the discard message may contain various indications to inform the receiver of which blocks are to be discarded. Therefore, for example, only the first and last BSNs of the discardable data blocks may be specified. Alternatively, the next BSN to which the receiver should advance the Rx window may be specified. In any case, for some embodiments, the receiver may check the fragmentation information for stored blocks as shown in 819. The fragmentation information may be used by the receiver to infer which stored blocks belong to the discarded MSDU, even if the transmitter discard message did not provide information specific for all MSDU blocks. For example, if a first block BSN was specified, then any blocks having “Continuing Fragment” or “Last Fragment” binary indications belonging to the same MSDU may be discarded prior to advancing the Rx window. For any of the above described embodiments, the receiver determines which additional data blocks if any must be discarded as shown in 821.

Therefore in 823, all data blocks related to the same MSDU for which any data block was to be discarded, as specified by the transmitter discard message, or as inferred by the receiver, may likewise be discarded. The receiver will then, in 825, update the block state to “received,” even though the blocks have in fact not been received, and send an ACK message to the transmitter in 827. The ACK message will inform the transmitter that the blocks were discarded. In 829, the receiver will advance its Rx window to the next BSN.

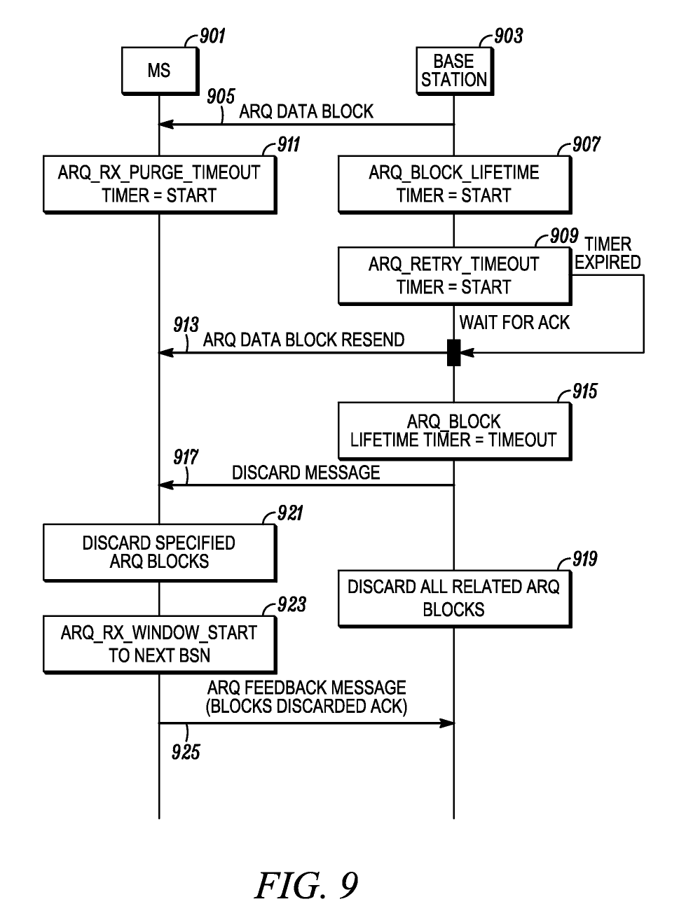

FIG. 9 is a message flow diagram providing an example of message flows between a transmitter and receiver in accordance with various embodiments. In FIG. 9, the base station 903 is assumed to be transmitting data blocks, while the mobile station (MS) 901 is assumed to be receiving data blocks. However, it is to be understood that in the various embodiments, communication of data is bi-directional such that the mobile station 901 may transmit data blocks, while the base station 903 may receive data blocks.

Therefore in accordance with the exemplary FIG. 9 assumption of base station 903 data transmission, an ARQ data block is sent to the MS 901 from base station 903 as signal 905. The base station will then set the timer “ARQ_BLOCK_LIFETIME TIMER” 907 and also set an “ARQ_RETRY_TIMEOUT TIMER” 909. On the receiver side, the MS 901 will set an “ARQ_RX_PURGE_TIMEOUT TIMER” 911.

Returning to the base station 903 side, and assuming that an ACK is not received, the timer 909 will timeout and the base station 903 will resend the data block 913. The resend 913 may also occur if a NACK message is received as was discussed above. In FIG. 9, it is assumed that an ACK message, or a NACK message, is never received by the base station 903 such that ARQ_BLOCK_LIFETIME TIMER 915 times out, in which case discard message 917 is sent to the MS 901.

The MS 901 will discard any specified ARQ blocks in 921, and may also infer other blocks not specified, if such blocks may be related to the same MSDU by using for example, the block fragmentation control information as was discussed above. The MS 901 will then advance the ARQ_RX_WINDOW_START 923 to the next BSN, and will send an ARQ feedback message 925 to the base station 903 indicating that the ARQ blocks have been discarded. The base station 903 likewise discards any ARQ blocks queued for the MSDU in 919.

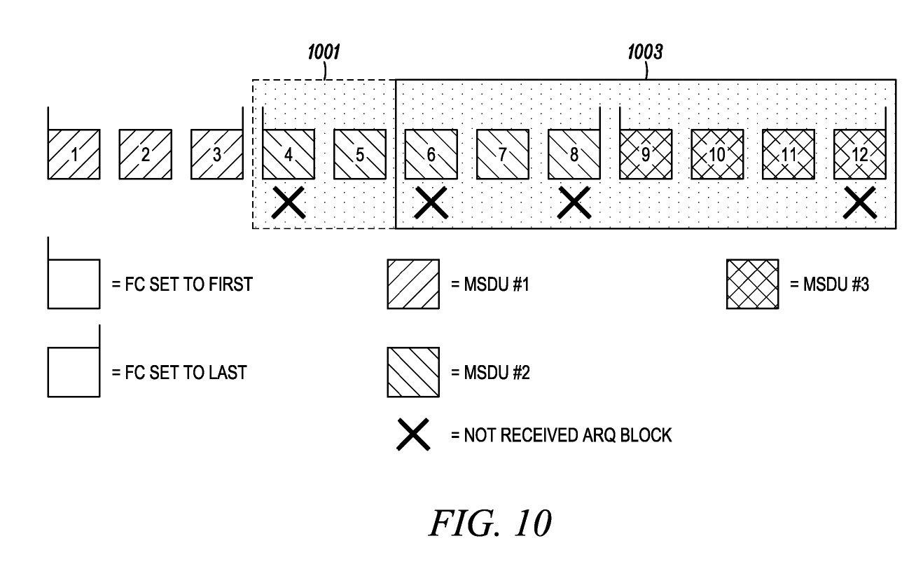

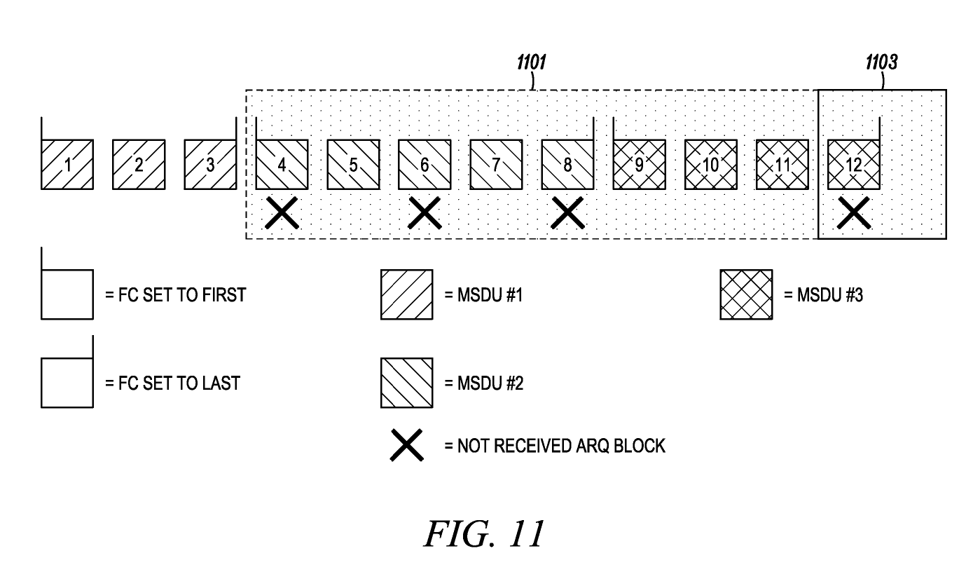

FIG. 10 illustrates how an ARQ sliding receiver window operates and FIG. 11 illustrates how the ARQ window operates in accordance with an embodiment. Therefore, in FIG. 10, when fragmentation is used on an ARQ connection, only a part of the ARQ blocks for a specific MSDU might be discarded because the MSDU may have been fragmented over several PDUs. As discussed in detail above, ARQ blocks may be discarded for various reasons, one of which is that, after multiple retries the ARQ_RX_PURGE_TIMEOUT TIMER 911 for example, may timeout on the receive side, or a discard message 917 may have been received when the transmitter ARQ_BLOCK_LIFETIME TIMER 915 timeout occurs, for example.

Therefore, in FIG. 10, in which various ARQ data blocks are represented as consecutive data blocks having BSNs 1 through 12, data blocks 1, 2 and 3 correspond to a first MSDU, while data blocks 4 through 8 correspond to a second MSDU. Block 5 has been received, while block 4 has not been received. If a discard message is received specifying data block 4 is to be discarded, the receiver will advance the window 1001 to BSN 6 as shown by window 1003. It is to be noted that data blocks 6, 7 and 8 also belong to the second MSDU, are still within the pending window 1003, and have not been discarded, even though theses blocks are no longer of any use.

Therefore, the various embodiments employ the technique illustrated by FIG. 11. Therefore as shown in FIG. 11, the receiver may utilize the fragmentation control (FC) information to deduct related ARQ blocks not yet received, because an FC indication of “First Fragment,” must be ended by an FC set to “Last Fragment.” Before the receiver sends an ARQ feedback message, the receiver may examine if any other ARQ blocks would complete the MSDU and thereby shift the receive window 1101 beyond these additional blocks as well.

It is assumed in FIG. 11 that either a receiver ARQ_RX_PURGE_TIMER timeout occurred for ARQ block 5, or that a discard message was received for ARQ block 4. The receiver may read the FC information of received blocks 5 and 7 determining that 5 and 7 are “Continuing Fragments” which can be discarded. The receiver may further note that 6 and 8, which have not been received, are a “Continuing Fragment” and a “Last Fragment,” respectively. Block 8 is logically inferred to be the “Last Fragment” of the discarded MSDU because received block 9 is a “First Fragment” of a new MSDU. Likewise, the receiver may determine that blocks 9, 10 and 11 are the “First Fragment,” and “Continuing Fragments” of a second MSDU and therefore the window may be advanced to window position 1103 which corresponds to BSN 12.

If the receiver is unable to deduct all information needed to discard a complete MSDU, one such case being where consecutive data blocks have not been received, then on reception of new information concerning this MSDU, the receiver may continue to discard the remaining MSDU data blocks. In the event of consecutive data blocks which are not received, and which are part of a discarded MSDU, the receiver will, in the various embodiments, set a discard flag. For example, assuming a discarded MSDU consists of data blocks 4 through 9 wherein all blocks have been received, except for blocks 6 and 7. In this case the receiver would forward the window to BSN 6 because it cannot determine whether blocks 6 and 7 are “Continuing Fragments,” or whether block 6 is a “Last Fragment” and block 7 is a “First Fragment” of a new MSDU. Therefore the receiver in this case can only safely discard up through “Continuing Fragment” block 5. However, when the receiver receives block 6 having FC information set to “Continuing Fragment,” it will discard blocks 6 through 9, and advance the window to BSN 10. Because block 8, which is a “Continuing Fragment,” and block 9, which is a “Last Fragment,” have been received, and because block 6, subsequently received is then known to be continuing, block 7 logically must likewise be continuing and may be discarded. Thus, the receiver appropriately discards blocks 6 though 9 and advances the receive window to BSN 10.

Additionally, it is to be understood that the transmitter side may also employ the techniques described above and illustrated by FIG. 11, in the event of for example an ARQ_BLOCK_LIFETIME TIMER 915 timeout, such that the blocks marked “not received” would be “not acknowledged” with respect to the transmitter side. The transmitter may thus accordingly advance the transmission window thereby saving unnecessary data block transmissions or retransmissions.

Returning briefly to FIG. 9, further optimizations may be employed by the various embodiments. For example, ARQ_RX_PURGE_TIMEOUT TIMER 911 may be applied to several data blocks simultaneously, if a set of data blocks having consecutive BSNs is received in a single PDU. Otherwise if the timer 911 is set for each individual data block, the timer for that block must be reset if a duplicate data block were received. Therefore, in the various embodiments, only a single purge timer is set for consecutive BSN data blocks received in a single PDU. The timer is then only reset in the event that duplicates of all BSNs within the PDU set have been received. Similarly on the transmitter side, the ARQ_BLOCK_LIFETIME_TIMER 907 may be applied to all ARQ data blocks that are sent in the same PDU.

While various embodiments have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of operating a wireless transceiver, said wireless transceiver operating in an Automatic Repeat Request (ARQ) mode, said method comprising:
fragmenting a packet of data into a series of sequential data blocks and assigning each of said data blocks a block sequence number;
sending at least a first data block from said series of sequential data blocks, and a first block sequence number corresponding to said first data block, to a remote wireless transceiver;
setting an acknowledgment timer specifying a time interval in which to receive an acknowledgment message from said remote transceiver, said acknowledgment message corresponding to said first data block;
determining that said acknowledgment timer has timed out; and
sending a discard message to said remote transceiver specifying at least a second block sequence number corresponding to at least a second data block, and specifying that said second data block is to be discarded.

2. The method of claim 1, further comprising:
discarding all remaining data blocks of said series of sequential data blocks.

3. The method of claim 2, further comprising:
advancing an ARQ transmission window start to the next block sequence number greater than a largest value block sequence number, said largest value block sequence number corresponding to a last in sequence data block of said series of sequential data blocks.

4. The method of claim 1, further comprising:
receiving from said remote transceiver, an acknowledgment message, said acknowledgment message specifying that said second data block has been discarded by said remote transceiver.

5. The method of claim 1, further comprising:
setting a retry timer specifying a time interval in which to receive a report message from said remote transceiver, said report message acknowledging receipt of said discard message;
determining that said retry timer has timed out; and
sending a second discard message to said remote transceiver.

6. A method of operating a wireless transceiver, said wireless transceiver operating in an Automatic Repeat Request (ARQ) mode, said method comprising:
receiving from a remote transceiver at least a first data block including a first block sequence number, said first data block being from a series of sequential data blocks forming a packet;
receiving from said remote transceiver a discard message specifying at least a second block sequence number corresponding to at least a second data block, said discard message specifying that said second data block is to be discarded; and
discarding said second data block.

7. The method of claim 6, further comprising:
sending a discard report message to said remote transceiver reporting that said second data block has been discarded.

8. The method of claim 7, further comprising:
advancing an ARQ receive window start to the next block sequence number greater than a largest value block sequence number, said largest value block sequence number corresponding to a last in sequence data block of said series of sequential data blocks.

9. The method of claim 6, further comprising:
receiving from said remote transceiver, a fragmentation information corresponding to said first data block;
setting a data purge timer specifying a time interval in which to receive at least a second data block from said series of sequential data blocks;
determining that said purge timer has timed out;
using said fragmentation information to determine a final block sequence number corresponding to a last in sequence data block of said series of sequential data blocks; and
advancing an ARQ receive window start to the next block sequence number greater than said final block sequence number.

10. A wireless communication station comprising:
a transceiver for transmitting and receiving radio signals;
a processor coupled to said transceiver, said processor having a medium access control layer, and configured to:
fragment a packet of data into a series of sequential data blocks and assign each of said data blocks a block sequence number;
send at least a first data block from said series of sequential data blocks, and a first block sequence number corresponding to said first data block, to a remote wireless transceiver;
set an acknowledgment timer specifying a time interval in which to receive an acknowledgment message from said remote transceiver, said acknowledgment message corresponding to said first data block;
determine that said acknowledgment timer has timed out; and
send a discard message to said remote transceiver specifying at least a second block sequence number corresponding to at least a second data block, and specifying that said second data block is to be discarded.

11. The wireless communication station of claim 10, wherein said processor is further configured to discard all remaining data blocks of said series of sequential data blocks.

12. The wireless communication station of claim 10, wherein said processor is further configured to advance an ARQ transmission window start to the next block sequence number greater than a largest value block sequence number, said largest value block sequence number corresponding to a last in sequence data block of said series of sequential data blocks.

13. The wireless communication station of claim 10, wherein said processor is further configured to receive from said remote wireless transceiver, an acknowledgment message, said acknowledgment message specifying that said second data block has been discarded by said remote wireless transceiver.

14. The wireless communication station of claim 10, wherein said processor is further configured to:
receive from said remote transceiver at least a first data block including a first block sequence number, said first data block being from a series of sequential data blocks forming a packet;
receive from said remote transceiver a discard message specifying at least a second block sequence number corresponding to at least a second data block, said discard message specifying that said second data block is to be discarded; and
discard said second data block.

15. The wireless communication station of claim 14, wherein said processor is further configured to send a discard report message to said remote transceiver reporting that said second data block has been discarded.

16. The wireless communication station of claim 14, wherein said processor is further configured to advance an ARQ receive window start to the next block sequence number greater than a largest value block sequence number, said largest value block sequence number corresponding to a last in sequence data block of said series of sequential data blocks.

17. The wireless communication station of claim 14, wherein said processor is further configured to:
receive from said remote transceiver, a fragmentation information corresponding to said first data block;
set a data purge timer specifying a time interval in which to receive at least a second data block from said series of sequential data blocks;
determine that said purge timer has timed out;
use said fragmentation information to determine a final block sequence number corresponding to a last in sequence data block of said series of sequential data blocks; and
advance an ARQ receive window start to the next block sequence number greater than said final block sequence number.

18. The wireless communication station of claim 10, wherein said transceiver for transmitting and receiving radio signal, transmits and receives radio signals in accordance with an orthogonal frequency division multiple access radio interface.

19. The wireless communication station of claim 10, wherein said packet of data is a Medium Access Control Layer Service Data Unit (MSDU).

20. The wireless communication station of claim 10, wherein said first block sequence number corresponding to said first data block, further includes a fragmentation control information.
